(19) United States
(12) Patent Application Publication
(10) Pub. No.: US 2020/0039877 A1
(43) Pub. Date: Feb. 6, 2020

(54) METHOD OF ELECTROSTATIC CHARGE REDUCTION OF GLASS BY SURFACE CHEMICAL TREATMENT

(71) Applicant: CORNING INCORPORATED, CORNING, NY (US)

(72) Inventors: Xiaoju Guo, Painted Post, NY (US); Yuhui Jin, Painted Post, NY (US); Robert George Manley, Vestal, NY (US); Wanda Jaina Walczak, Big Flats, NY (US)

(21) Appl. No.: 16/492,241

(22) PCT Filed: Feb. 28, 2018
(86) PCT No.: PCT/US18/20155

§ 371 Date: Sep. 9, 2019

Related U.S. Application Data
(60) Provisional application No. 62/469,090, filed on Mar. 9, 2017.
(60) Provisional application No. 62/550,894, filed on Aug. 28, 2017.

(51) Int. Cl. C03C 21/00; C03C 15/02

(52) U.S. Cl. CPC C03C 21/005; C03C 15/02

(57) ABSTRACT

Disclosed devices include a liquid crystal layer and a cover glass comprising at least one major surface having a depleted or enriched surface layer. Methods for reducing mura in a touch-display device are also disclosed.

### CROSS-REFERENCE TO RELATED APPLICATIONS

This application claims the benefit of priority under 35 U.S.C. § 119 of U.S. Provisional Application Ser. No. 62/550894 filed on Aug. 28, 2017, and U.S. Provisional Application Ser. No. 62/469090 filed on Mar. 9, 2017, the content of each is relied upon and incorporated herein by reference in its entirety.

### FIELD OF THE DISCLOSURE

The disclosure relates generally to displays having reduced electrostatic surface charge and methods for reducing surface charge in such displays, and more particularly to displays including a cover glass sheet having at least one depleted or enriched surface layer to reduce mura and/or unintended liquid crystal modulation caused by the build-up of electrostatic charge.

### BACKGROUND

Displays with a thin film transistor (TFT) liquid crystal display (LCD) are commonly incorporated into touchscreen devices such as smartphones. TFT LCDs typically have liquid crystals, TFTs, a VCOM layer, and a color filter arranged between a color filter glass and a TFT array glass. A polarizer and a cover glass are also typically arranged above the color filter glass. One or more touch sensors may also be included in a display to provide combined touch and display functionality, referred to herein as a “touch-display” assembly, such as an LCD touch screen.

LCD touch screens can be arranged in various configurations, including “on cell,” “in-cell,” or “in-cell hybrid” configuration. In an on-cell configuration the touch sensor is disposed on an outer surface of the color filter glass, e.g., a surface facing the user. In an in-cell configuration the touch sensor is disposed within the cell, e.g., between the TFT array glass and the color filter glass. An in-cell hybrid configuration can comprise receive (RX) sensor layers arranged in a y direction and transmit (TX) sensor layers arranged in the x direction. The RX sensor layer is disposed on an outer surface of the color filter glass and the TX sensor layer is combined with the VCOM layer and is disposed between the color filter glass and the TFT array glass. Thus an exemplary in-cell hybrid display would at least include: a TFT array glass; TFTs disposed on the TFT array glass; the combined VCOM and TX sensor layer disposed on the TFTs; the liquid crystal layer disposed on the combined VCOM and TX sensor layer; the color filter disposed on the liquid crystal layer; the color glass filter disposed on the color filter; the RX sensors layer disposed on the color filter glass; a polarizer disposed on the RX sensors layer, and a cover glass disposed on the polarizer.

When static electricity is created on the cover glass bonded to an in-cell hybrid display, for example by moving a finger across the cover glass, an electrostatic charge builds up and creates an electric field between the RX sensor layer and the TX sensor layer. The electric field can lead to unintentional modulation of the liquid crystal layer which, in turn, leads to light leakage, also referred to herein as mura. As such, there is a need to solve the problem of mura induced by electrostatic charge building up on the cover glass.

### SUMMARY

The disclosure relates, in various embodiments, to methods for reducing mura in a touch-display device, the methods comprising treating a cover glass sheet to produce a depleted surface layer on at least one of a first major surface or a second major surface of the cover glass sheet and positioning the cover glass sheet proximate a liquid crystal layer in a touch-display device, wherein a surface concentration of at least one alkali metal ion in the depleted surface layer is less than a bulk concentration of the at least one alkali metal ion in the cover glass sheet, and wherein a depth of the depleted surface layer ranges from about 5 nm to about 100 nm. The disclosure also relates, in additional embodiments, to methods for reducing mura in a touch-display device, the methods comprising treating a cover glass sheet to produce an enriched surface layer on at least one of a first major surface or a second major surface of the cover glass sheet and positioning the cover glass sheet proximate a liquid crystal layer in a touch-display device, wherein a silica concentration of the enriched surface layer is greater than a bulk silica concentration of the cover glass sheet, and wherein a depth of the enriched surface layer ranges from about 5 nm to about 100 nm.

According to various embodiments, the cover glass sheet can comprise an alkali-containing glass chosen from borosilicate, aluminosilicate, and soda-lime glasses. In certain embodiments, treating the cover glass sheet can comprise at least one ion exchange step, at least one leaching or etching step, or a combination thereof. The ion exchange step can comprise a temperature ranging from about 20° C. to about 120° C. and/or a treatment period ranging from about 30 seconds to about 10 minutes. According to some embodiments, the ion exchange step comprises contacting at least one of the first and second major surfaces of the cover glass sheet with a salt bath comprising at least one cation chosen from H₃O⁺, Na⁺, K⁺, Cs⁺, Ag⁺, and Au⁺.

In some embodiments, treating the cover glass sheet to create a depleted or enriched surface layer can comprise a leaching or etching step. The leaching or etching step can comprise contacting at least one of the first and second major surfaces of the cover glass sheet with a leachant or etchant comprising at least one compound chosen from fluoride compounds, mineral acids, organic acids, and combinations thereof. According to non-limiting embodiments, the etchant can comprise a combination of (a) at least one fluoride compound and (b) at least one of a mineral acid and organic acid. The leaching or etching compound(s) can, in various embodiments, be chosen from HF, NH₄F, F₂H₅N, NaF, KF, HCI, HNO₃, H₂SO₄, H₃PO₄, and CH₃COOH. The leaching or etching step can comprise a temperature ranging from about 20° C. to about 90° C. and/or a treatment time ranging from about 10 seconds to about 10 minutes.

Also disclosed herein are devices comprising a liquid crystal layer and a cover glass sheet positioned proximate the liquid crystal layer and comprising first and second major surfaces, wherein at least one of the first and second major surfaces comprises a depleted surface layer, wherein a surface concentration of at least one alkali metal ion in the depleted surface layer is less than a bulk concentration of the at least one alkali metal ion in the cover glass sheet, and wherein a depth of the depleted surface layer ranges from about 5 nm to about 100 nm. The disclosure further relates to devices comprising a liquid crystal layer and a cover glass sheet positioned proximate the liquid crystal layer and comprising first and second major surfaces, wherein at least one of a first major surface and a second major surface of the cover glass sheet comprises an enriched surface layer having a silica concentration greater than a bulk silica concentration of the cover glass sheet, and wherein a depth of the enriched surface layer ranges from about 5 nm to about 100 nm. Display, electronic, and lighting devices comprising such devices are also disclosed herein.

According to various embodiments, the cover glass sheet can comprise an alkali-containing glass chosen from borosilicate, aluminosilicate, and soda-lime glasses. In non-limiting embodiments, the alkali metal ion is lithium. According to additional embodiments, the surface concentration of the at least one alkali metal ion in the depleted surface layer ranges from 0 mol % to about 5 mol %. In further embodiments, the silica concentration of the enriched surface layer is at least about 1 mol % greater than the bulk silica concentration of the cover glass sheet. According to yet further embodiments, both the first and second major surfaces of the cover glass sheet can comprise a depleted or enriched surface layer. In various embodiments, the device is a liquid crystal touch-display further comprising at least one of a polarizer, a receive (RX) sensor layer, a transmit (TX) sensor layer, a thin film transistor (TFT) array, a color filter glass, a color filter, and an anti-finger print layer.

Additional features and advantages of the disclosure will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the various embodiments.

### BRIEF DESCRIPTION OF THE DRAWINGS

The following detailed description can be further understood when read in conjunction with the following drawings. Whenever possible, the same reference numerals will be used throughout the drawings to refer to the same or like parts.

FIG. 1 depicts an exemplary touch-display device;

FIGS. 2A-B demonstrate the effect of electrostatic charge on liquid crystal alignment;

FIGS. 3A-B depict a cover glass sheet before and after an ion exchange step;

FIGS. 4A-B depict a cover glass sheet before and after a leaching or etching step;

FIGS. 5A-C depict cover glass sheets having depleted surface layers, enriched surface layers, or both depleted and enriched surface layers, respectively.

FIGS. 6A-F are graphs illustrating electrostatic charge on a glass surface as a function of time after tribo-charging for untreated and ion-exchanged glass samples;

FIG. 7 is a graph illustrating lithium oxide concentration as a function of depth for ion-exchanged glass samples;

FIG. 8 is a graph illustrating electrostatic charge on a glass surface as a function of time after tribo-charging for untreated and ion-exchanged/etched glass samples;

FIGS. 9A-B are bar charts of elemental concentration for ion-exchanged/etched glass samples;

FIGS. 10A-F are graphs illustrating electrostatic charge on a glass surface as a function of time after tribo-charging for untreated and ion-exchanged/leached glass samples;

FIG. 11 is a bar chart of sheet resistance for untreated and ion-exchanged/leached glass samples;

FIGS. 12A-B are graphs illustrating DC current on a glass surface as a function of time for untreated and ion-exchanged/leached glass samples; and

FIGS. 13A-B illustrate schematics for various experimental set-ups disclosed herein.

### DETAILED DESCRIPTION

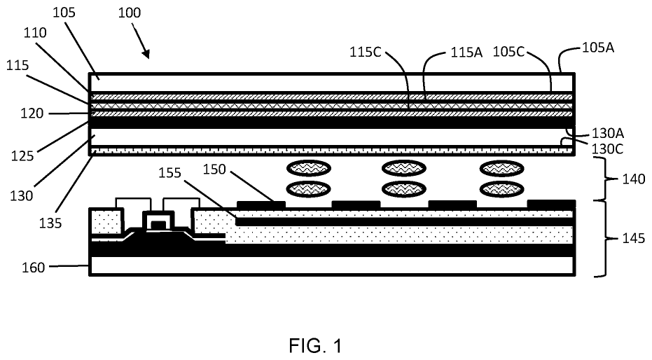

Various embodiments of the disclosure will now be discussed with reference to FIGS. 1-13B, which illustrate non-limiting embodiments of the disclosure and various components and aspects thereof. The following general description is intended to provide an overview of the claimed devices and methods, and various embodiments will be more specifically discussed throughout the disclosure with reference to the non-limiting depicted embodiments, these embodiments being interchangeable with one another within the context of the disclosure.

Methods

Disclosed herein are methods for reducing mura in a touch-display device, the methods comprising treating a cover glass sheet to produce a depleted surface layer on at least one of a first major surface or a second major surface of the cover glass sheet and positioning the cover glass sheet proximate a liquid crystal layer in a touch-display device, wherein a surface concentration of at least one alkali metal ion in the depleted surface layer is less than a bulk concentration of the at least one alkali metal ion in the cover glass sheet, and wherein a depth of the depleted surface layer ranges from about 5 nm to about 100 nm.

Also disclosed herein are methods for reducing mura in a touch-display device, the methods comprising treating a cover glass sheet to produce an enriched surface layer on at least one of a first major surface or a second major surface of the cover glass sheet and positioning the cover glass sheet proximate a liquid crystal layer in a touch-display device, wherein a silica concentration of the enriched surface layer is greater than a bulk silica concentration of the cover glass sheet, and wherein a depth of the enriched surface layer ranges from about 5 nm to about 100 nm.

FIG. 1 illustrates a non-limiting example of a display device 100 having an in-cell hybrid configuration. The display device may include, for example, a cover glass 105, a polarizer 115, an RX sensor layer 125, a liquid crystal layer 140, and a TFT assembly 145. The cover glass 105 can include a first major surface 105A and a second major surface 105C. The polarizer 115 can likewise include a first major surface 115A and a second major surface 115C. In non-limiting embodiments, the display device 100 may be oriented such that the first major surfaces disclosed herein (105A, 115A, etc.) are forward-facing, e.g., facing toward a user, whereas the second major surfaces disclosed herein (105C, 115C, etc.) are rear-facing, e.g., facing toward the back of the device. Of course, the configuration illustrated in FIG. 1 is exemplary only and is not intended to be limiting on the appended claims.

The terms “first” and “second” major surfaces may be used herein interchangeably to refer to opposing major surfaces of a component. In some embodiments, a “first” major surface may denote a front surface facing an intended user, e.g., emitting light toward or displaying an image to a user. Similarly, a “second” major surface may denote a rear surface facing away from the user, e.g., towards a rear panel of a device, if present.

In various embodiments, additional components and/or layers may be present in the display device 100. Referring again to the non-limiting embodiment depicted in FIG. 1, the display device 100 may include a first adhesive layer 110 positioned between cover glass 105 and polarizer 115. In various embodiments, first adhesive layer 110 may be in direct physical contact with both the cover glass 105 (e.g., second major surface 105C) and the polarizer 115 (e.g., first major surface 115A), such that a bond is formed between these components. A second adhesive layer 120 may also be positioned between the polarizer 115 and the RX sensor layer 125. According to non-limiting embodiments, the second adhesive layer may be in direct physical contact with both the polarizer 115 (e.g., second major surface 115C) and the RX sensor layer 125, such that a bond is formed between these components.

In the in-cell hybrid configuration illustrated in FIG. 1, the RX sensor layer 125 may be disposed on the first major surface 130A of color filter glass 130. A color filter 135 may be disposed on the second major surface 130C of the color filter glass 130. The liquid crystal (LC) layer 140 may, in some embodiments, be positioned between the color filter glass 130 and the TFT assembly 145. The LC layer 140 may be in direct contact with the color filter 135 and the TFT assembly 145, or one or more optional components and/or layers may be present therebetween, such as adhesive layers and the like. An exemplary LC layer 140 may include any type of liquid crystal material arranged in any configuration known in the art, such as a TN (twisted nematic) mode, a VA (vertically aligned) mode, an IPS (in plane switching) mode, a BP (blue phase) mode, a FFS (Fringe Field Switching) mode, and an ADS (AdvancedSuper Dimension Switch) mode, to name a few.

The TFT assembly 145 can comprise various components and/or layers, such as a layer of individual pixel electrodes and a common voltage (VCOM) electrode layer shared by all pixels. In the illustrated in-cell hybrid configuration, the transmit (TX) sensor layer 155 may also serve as the common voltage (VCOM) electrode layer and thus, may be interchangeably referred to herein as the TX/VCOM layer. Together with pixel electrodes 150, the TX/VCOM layer 155 can generate an electric field upon application of voltage across the electrodes. This electric field can determine the orientation direction of liquid crystal molecules in the liquid crystal layer 140. A TFT glass 160 may be used as a support for the various components of the TFT array.

The term “positioned between” and variations thereof is intended to denote that a component or layer is located between the listed components, but not necessarily in direct physical contact with those components. For instance, the polarizer 115 is positioned between the RX sensor layer 125 and cover glass 105 as illustrated in FIG. 1, but is not in direct physical contact with either of these layers. However, a component positioned between two listed components may also, in certain embodiments, be in direct physical contact with one or more of the listed components. As such, a component A positioned between components B and C may be in direct physical contact with component B, in contact with component C, or both.

Similarly, the term “positioned proximate” and variations thereof is intended to denote that a component or layer is located near a listed component, but not necessarily in direct physical contact with that component. Other layers or components may be positioned between two components or layers that are positioned proximate each other. For instance, the cover glass 105 is positioned proximate the LC layer 140 as illustrated in FIG. 1, but is not in direct physical contact with that layer. As such, a component A positioned proximate a component B may or may not be in direct physical contact with component B.

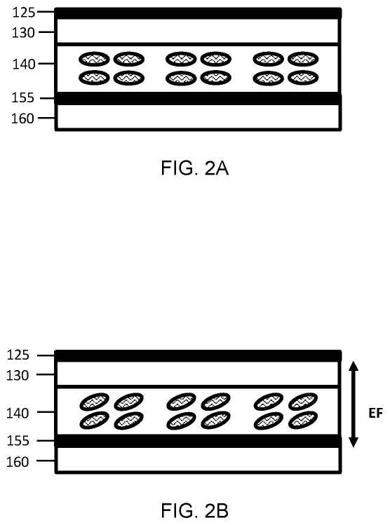

Referring now to FIGS. 2A-B, a mechanism is shown by which static electricity can develop mura in LC display devices. FIG. 2A depicts a simplified LC display device in its initial state, e.g., prior to exposure to static electricity. The LC layer 140 in FIG. 2A is properly aligned and blocks light from undesirably leaking through to the user. When static electricity is created in the device, for example, when a finger is moved across the cover glass, when a protective coating is peeled off the cover glass, or other like motions, an electrostatic charge may develop. As shown in FIG. 2B, the electrostatic charge generates a vertical electric field EF between the RX sensor layer 125 on the color filter glass 130 and the TX sensor layer 155 on the TFT glass 160. The electric field EF causes the liquid crystals in the LC layer 140 to spin undesirably and light is no longer blocked in those locations, resulting in localized regions of mura. The user may perceive, for example, cloudiness, color distortion, and/or a reduction in local contrast and/or brightness in the regions of the display corresponding to the misaligned liquid crystals.

An electric field generated by electrostatic surface charge, such as that illustrated in FIG. 2B, can impact the LC orientation within a LC display device. Such a reorientation can manifest as mura (light leakage) visible to the user. Two factors can impact mura: relaxation time of charge and amount of charge. If the charge relaxation time exceeds that of the LC director (approx. 10⁻²-10⁻¹ s) or if the amount of charge exceeds the threshold value of the LC director, the LC will reorient in response to the field. Mura can often have a transient nature with a characteristic time of 10⁻¹-10² seconds and can be affected by various factors such as size of the LC panel, gray level, and LC mode. In case of very high relaxation time and/or charge amount, mura retention can last as long as 10²-10³ seconds. In such cases, the relaxation time is no longer controlled by the viscous torque of the LC director and is instead controlled by the movement and adsorption of impurity ions and associated DC field within the LC cell, resulting in image sticking. One possible scenario for image sticking is a combination of repeated static charges with long relaxation times that lead to a cumulative impact.

To avoid the temporary period of liquid crystal misalignment depicted in FIG. 2B, it may be desirable to reduce, eliminate, or otherwise neutralize any electrostatic charge in the display device before such charge affects the LC layer 140. In some embodiments, at least one major surface of the cover glass sheet may be treated to produce a depleted or enriched layer. In certain embodiments, a treated cover glass comprising one or more depleted surface layers as disclosed herein can have reduced electrostatic charge generation as compared to an untreated cover glass. In other embodiments, a treated cover glass comprising one or more enriched layers can have improved surface conductivity as compared to an untreated cover glass, such that the treated cover glass can more quickly dissipate electrostatic charge generated on the glass surface. Several different embodiments for reducing and/or dissipating electrostatic charge are discussed below.

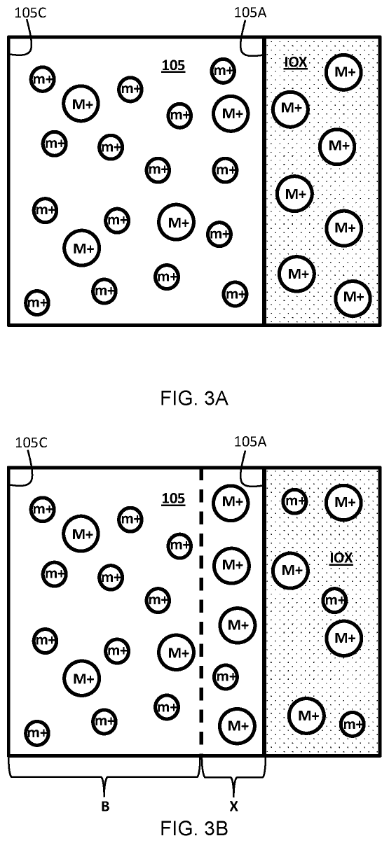

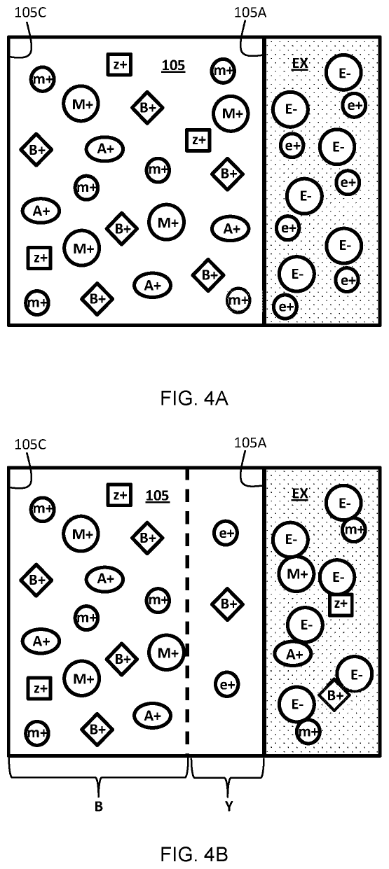

Certain embodiments of the disclosure will be discussed with reference to FIGS. 3-4. For illustrative purposes, FIGS. 3-4 depict cross-sectional views of the cover glass 105 only. However, it is to be understood that the depicted embodiments can also comprise any other components and/or layers depicted in FIG. 1 or otherwise described herein, or any combination thereof without limitation.

As shown in FIG. 3A, a cover glass 105 can comprise one or more alkali metal ions with various diameters. Smaller alkali metal ions m+ may have a higher mobility than larger alkali metal ions M+. Alkali metal ions range in diameter, from smallest to largest, from Li⁺ to Cs⁺ (e.g., Li⁺<Na⁺<K⁺<Rb⁺<Cs⁺). In some embodiments, the smaller alkali metal ions m+ can be chosen from Li⁺ and Na⁺, and the larger alkali metal ions M+ can be chosen from K⁺, Rb⁺, and Cs⁺. The higher mobility of the smaller alkali metal ions m+ can allow them to move more easily under an applied voltage, which may promote electrostatic charge build-up on the cover glass sheet. According to various embodiments, the methods disclosed herein can be used to create one or more depleted surface layers on a first major surface 105A or second major surface 105C of the cover glass sheet 105. The depleted surface layer may, for example, have a concentration of at least one alkali metal ion that is lower than the bulk concentration of the at least one depleted alkali metal ion in the cover glass sheet.

By way of non-limiting example, as shown in FIGS. 3A-B, a depleted surface layer X may be formed by one or more ion exchange steps, e.g., by contacting at least one major surface of the cover glass sheet 105 with an ion exchange bath IOX. The ion exchange bath may, in some embodiments, comprise one or more salts comprising a larger alkali metal ion M+, as depicted in FIG. 3A. In other embodiments, the salt bath may include other cations, such as Ag⁺, Au⁺, or Au³⁺, to name a few. During the ion exchange process, smaller alkali metal ions m+ within the cover glass sheet at or near the first or second major surface may be exchanged for larger metal ions, e.g., larger alkali metal ions M+, as shown in FIG. 3B. Although not illustrated, it is also possible to exchange smaller alkali metal ions m+ and/or larger alkali metal ions M+ with other cations (e.g., Ag⁺, Au⁺, Au³⁺, etc.).

The incorporation of the larger ions into the cover glass sheet and the removal of the smaller ions can form a depleted surface layer X having a lower concentration of smaller alkali metal ions m+ as compared to the bulk concentration of smaller alkali metal ions m+ in the bulk B of the cover glass sheet. Although not illustrated, the depleted surface layer may also have a lower concentration of larger alkali metal ions M+ as compared to the bulk concentration of larger alkali metal ions M+ in the bulk of the cover glass sheet, depending on the ion exchange bath composition. In certain embodiments, the depleted surface layer may comprise 0 mol % (or less than about 0.01 mol %, less than about 0.1 mol %, less than about 0.5 mol %, or less than about 1 mol %) of the smaller alkali metal ion m+ and the bulk B of the cover glass may comprise greater than 0 mol % (or greater than about 0.01 mol %, less than about 0.1 mol %, less than about 0.5 mol %, or less than about 1 mol %) of the smaller alkali metal ion m+. In other embodiments, the depleted surface layer may comprise 0 mol % (or less than about 0.01 mol %, less than about 0.1 mol %, less than about 0.5 mol %, or less than about 1 mol %) of the larger alkali metal ion M+ and the bulk B of the cover glass may comprise greater than 0 mol % (or greater than about 0.01 mol %, less than about 0.1 mol %, less than about 0.5 mol %, or less than about 1 mol %) of the larger alkali metal ion M+. By decreasing the concentration and/or mobility of alkali metal ions m+ and/or M+ in the depleted surface layer X of the first and/or second major surface 105A, 105C, the charge generation of the treated surface(s) may be reduced such that electrostatic charge cannot easily be generated on the treated surface.

Ion exchange may be carried out, for example, by contacting at least one major surface of the cover glass with a salt bath for a predetermined period of time. Exemplary salts that can be used in the salt bath include, but are not limited to, LiNO₃, NaNO₃, KNO₃, RbNO₃, CsNO₃, AgNO₃, AuNO₃, and combinations thereof. Exemplary solvents that can be used in the salt bath include, for instance, water; aliphatic alcohols, such as methanol, ethanol, and isopropanol; glycols, such as ethylene glycol and propylene glycol; and combinations thereof. A concentration of the salt(s) in the ion exchange bath can range, in some embodiments, from about 0.01M to about 3M, such as from about 0.05M to about 2M, from about 0.1M to about 1.5M, or from about 0.5 to about 1M, including all ranges and subranges therebetween.

The temperature and/or treatment period for the ion exchange step can vary but may, in certain embodiments, be mild as compared to traditional ion exchange strengthening processes. By way of a non-limiting example, the temperature of the salt bath may range from about 20° C. to about 120° C., such as from about 30° C. to about 100° C., from about 40° C. to about 90° C., from about 50° C. to about 80° C., or from about 60° C. to about 70° C., including all ranges and subranges therebetween. Similarly, the treatment period may be shorter than traditional ion exchange strengthening processes and may, for example, range from about 30 seconds to about 10 minutes, such as from about 45 seconds to about 9 minutes, from about 1 minute to about 8 minutes, from about 2 minutes to about 7 minutes, from about 3 minutes to about 6 minutes, or from about 4 minutes to about 5 minutes, including all ranges and subranges therebetween.

According to various embodiments, a surface concentration of the at least one depleted alkali metal ion in the depleted surface layer X can range from 0 mol % to about 5 mol %, such as from about 0.01 mol % to about 4 mol %, from about 0.05 mol % to about 3 mol %, from about 0.1 mol % to about 2 mol %, or from about 0.5 mol % to about 1 mol %, including all ranges and subranges therebetween. In certain embodiments, the at least one depleted alkali metal ion can be chosen from Li+, Na+, or both. In other embodiments, the depleted alkali metal ion can be Li+.

Although not depicted in FIGS. 3A-B, formation of the depleted surface layer X can also be achieved by one or more leaching or etching steps, as discussed in more detail below with reference to FIGS. 4A-B. According to non-limiting embodiments, the depleted surface layer X can be formed by a combination of ion exchange and leaching or etching steps. For instance, one or more leaching or etching steps may be performed after one or more ion exchange steps, or such steps may be alternated or combined in any other suitable sequence to achieve the desired depleted surface layer X.

Referring now to FIG. 4A, a cover glass sheet 105 can comprise smaller alkali metal ions m+ and/or larger alkali metal ions M+. The cover glass sheet 105 can also comprise one or more alkaline earth metal ions A+ (e.g., Be²⁺, Mg²⁺, Ca²⁺, Sr²⁺, and Ba²⁺). Other cations present in the cover glass sheet can include glass-forming cations B+, such as Al³⁺, B³⁺, Zn²⁺, and P⁵⁺, as well as any metallic impurities z+, such as Fe²⁺, Fe³⁺, Cu⁺, Cu²⁺, Sb³⁺, Sb⁵⁺, As³⁺, and As⁵⁺. According to various embodiments, the methods disclosed herein can be used to create one or more depleted surface layers on a first major surface 105A or second major surface 105C of the cover glass sheet 105. The depleted surface layer may, for example, have a concentration of at least one alkali metal ion, at least one alkaline earth metal ion, at least one glass-forming ion, and/or at least one metallic impurity ion that is lower than the bulk concentration of said ion(s) in the cover glass sheet.

By way of non-limiting example, as shown in FIGS. 4A-B, one or more leaching or etching steps may be employed, e.g., by contacting at least one major surface of the cover glass sheet 105 with at least one etchant EX or leachant (not illustrated). The etchant EX (or leachant) may, in some embodiments, comprise one or more compounds chosen from fluoride compounds, mineral acids, organic acids, or any combination thereof. In certain embodiments, the etchant EX can comprise a mixture of at least one fluoride compound with at least one of a mineral acid or an organic acid. Exemplary fluoride compounds include, but are not limited to, hydrofluoric acid (HF), ammonium fluoride (NH₄F), ammonium bifluoride (F₂H₅N), sodium fluoride (NaF), and potassium fluoride (KF). Non-limiting examples of mineral acids include, for instance, hydrochloric acid (HCI), hydrofluoric acid (HF), nitric acid (HNO₃), sulfuric acid (H₂SO₄), and phosphoric acid (H₃PO₄). Acetic acid (CH₃COOH) may be used as an organic acid in some embodiments.

The etchant EX (or leachant) may, in some embodiments, be in the form of a solution further comprising one or more solvents and one or more etching or leaching compounds (e.g., fluoride compounds, mineral acids, and/or organic acids). Exemplary solvents that can be used in the etchant or leachant solution include, for instance, water; aliphatic alcohols, such as methanol, ethanol, and isopropanol; glycols, such as ethylene glycol and propylene glycol; and combinations thereof. A total concentration of the etching or leaching compound(s) in the solution can range, in some embodiments, from about 0.05M to about 3M, such as from about 0.1M to about 2.5M, from about 0.5M to about 2M, or from about 1M to about 1.5M, including all ranges and subranges therebetween. According to various embodiments, the concentration of fluoride compound(s) in the solution can range from about 0.01M to about 2M, such as from about 0.05M to about 1.5M, from about 0.1M to about 1M, from about 0.2M to about 0.9M, from about 0.3M to about 0.8M, from about 0.4M to about 0.7M, or from about 0.5M to about 0.6M, including all ranges and subranges therebetween. Similarly, the concentration of mineral acid(s) and/or organic acid(s) in the solution can range from about 0.01M to about 2M, such as from about 0.05M to about 1.5M, from about 0.1M to about 1M, from about 0.2M to about 0.9M, from about 0.3M to about 0.8M, from about 0.4M to about 0.7M, or from about 0.5M to about 0.6M, including all ranges and subranges therebetween.

The temperature and/or treatment period for the leaching or etching step can vary as appropriate to achieve a desired enrichment layer. By way of a non-limiting example, the leaching or etching step may be carried out at a temperature ranging from about 20° C. to about 90° C., such as from about 30° C. to about 80° C., from about 40° C. to about 70° C., or from about 50° C. to about 60° C., including all ranges and subranges therebetween. The treatment period may range, in some embodiments from about 10 seconds to about 10 minutes, such as from about 20 seconds to about 9 minutes, from about 30 seconds to about 8 minutes, from about 40 seconds to about 7 minutes, from about 1 minute to about 6 minutes, from about 2 minutes to about 5 minutes, or from about 3 minutes to about 4 minutes, including all ranges and subranges therebetween.

During the etching or leaching process, smaller alkali metal ions m+, larger alkali metal ions M+, alkaline earth metal ions A+, glass-forming ions B+, and/or metallic impurity ions z+ may migrate to the first or second major surface where they can react with the anions E− to form a reaction product or complex (e.g., E−m+, E−M+, E−A+, E−B+, E−z+), which may or may not be soluble in the etchant or leachant solution. The removal of ions m+, M+, A+, B+, and/or z+ from the cover glass sheet can form an enriched surface layer Y having a relatively high silica concentration as compared to the bulk concentration of silica in the bulk B of the cover glass sheet. The enriched surface layer Y may likewise be depleted of one or more cations and, thus, can also be described as a depleted surface layer in some embodiments.

In certain embodiments, the enriched surface layer Y may comprise at least about 0.1 mol % more silica than the bulk B of the cover glass, such as at least about 0.5 mol %, 1 mol % 2 mol %, 3 mol %, 4 mol %, 5 mol %, 6 mol %, 7 mol %, 8 mol %, 9 mol %, 10 mol %, or more, as compared to the bulk silica concentration in the bulk B of the glass. According to various embodiments, one or more cations e+, such as hydrogen (H⁺) ions, may also migrate into the enriched surface layer Y. By increasing the relative concentration of silica and/or hydrogen ions in the enriched surface layer Y of the first and/or second major surface 105A, 105C, the conductivity of the treated surface(s) may be increased such that electrostatic charge on the treated surface can be more quickly dissipated.

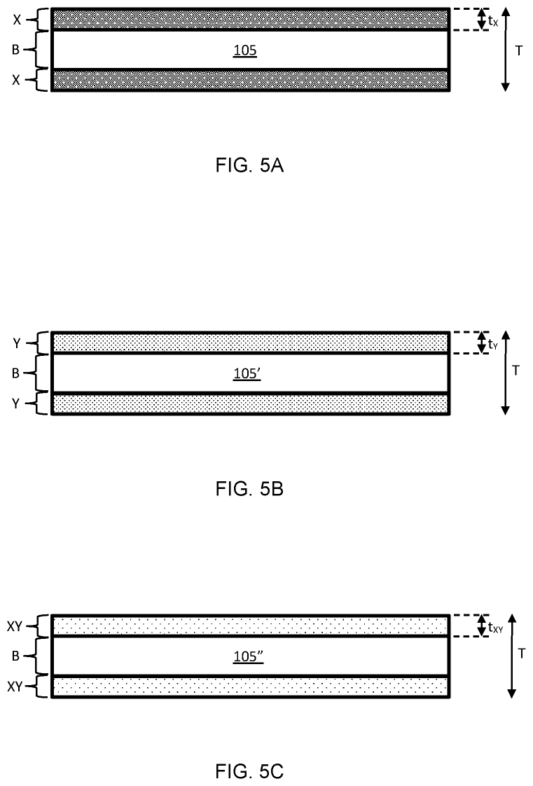

While FIGS. 3-4 illustrate the depleted surface layer X and the enriched surface layer Y, respectively, on only the first major surface 105A, it is to be understood that such a layer X and/or Y can also be present on the second major surface 105C or on both the first and second major surfaces 105A and 105C. In non-limiting embodiments, as illustrated in FIG. 5A, the cover glass can comprise two depleted surface layers X. Such a cover glass 105 can be obtained, in some embodiments, by ion exchanging both the first and second major surfaces of the cover glass. Similarly, as illustrated in FIG. 5B, the cover glass can comprise two enriched surface layers Y. Such a cover glass 105′ can be obtained, in certain embodiments, by leaching or etching both the first and second major surfaces of the cover glass. Furthermore, as illustrated in FIG. 5C, the cover glass 105 can comprise two depleted/enriched surface layers XY. Such a cover glass 105″ can be obtained, for example, by ion exchanging and leaching or etching both the first and second major surfaces of the cover glass.

Of course, the cover glass may, in various embodiments, comprise only one depleted surface layer X, enriched surface layer Y, or depleted/enriched surface layer XY on the first or second major surface. Alternatively, the first and second major surfaces can comprise different layers, such as a depleted surface layer X on the first major surface and an enriched surface layer Y or depleted/enriched surface layer XY on the second major surface, or vice versa, without limitation. Additionally, while FIGS. 5A-C depict the layers X, Y, and XY, respectively as entirely covering the first and second major surfaces of the cover glass, it is to be understood that such layers may be disposed on only a portion of the first and/or second major surface, e.g., on a central or peripheral portion of the surface, or applied to any other portion of the surface in any desired pattern.

Referring again to FIGS. 5A-C, the depth of the depleted surface layer X (tₓ), the enriched surface layer Y (t_{y}), and/or the depleted/enriched surface layer XY (tₓy) can be identical or different and can range, in some embodiments, from about 5 nm to about 100 nm, such as from about 10 nm to about 90 nm, from about 15 nm to about 80 nm, from about 20 nm to about 70 nm, from about 30 nm to about 60 nm, or from about 40 nm to about 50 nm, including all ranges and subranges therebetween. According to certain embodiments, the layer thickness tₓ, t_{y}, and/or t_{xy} can be relatively shallow as compared to the overall thickness T of the cover glass. For example, the thickness of the X, Y, and/or XY layer can range from about 0.0001% to about 1% of the overall thickness T, such as from about 0.001% to about 0.5%, from about 0.005% to about 0.1%, or from about 0.01% to about 0.05% of the overall thickness T, including all ranges and subranges therebetween. While FIGS. 5A-C depict the layers X, Y, and XY as having substantially the same depth, the thickness of these layers may vary and tₓ, t_{y}, and/or t_{xy} may have substantially equal values or different values.

In some embodiments, the layer(s) X, Y, and/or XY may be positioned on the first major (front) surface 105A of the cover glass 105 and may thus be contacted by a user, e.g., when the surface is rubbed, when a protective plastic film is removed, or when the surface is otherwise charged by user interaction. The layer(s) X, Y, and/or XY may also be positioned on the second major (rear) surface 105C of the cover glass 105 and may thus not be contacted by a user, but can still serve to reduce electrostatic charge generation and/or increase electrostatic charge dissipation. In some embodiments, generation of electrostatic charge may be reduced or eliminated by depleted surface layer X, enriched surface layer Y, or depleted/enriched surface layer XY, such that electrostatic charge sufficient to modulate the underlying LC layer cannot be generated. In additional embodiments, the depleted surface layer X, enriched surface layer Y, or depleted/enriched surface layer XY can facilitate electrostatic charge dissipation such that electrostatic charge is directed towards the edges of the glass sheet before it can accumulate and interfere with the underlying LC layer.

After treating the first and/or second major surface of the cover glass to produce the desired layer, e.g., by ion exchange and/or leaching/etching steps, the treated cover glass may be rinsed and/or dried to remove salts, etchants, reaction products, and/or solvents. For instance, the treated cover glass may be rinsed one or more times with water, such as deionized water. After rinsing, the treated cover glass can be dried at room temperature or elevated temperatures up to about 200° C. for a time period ranging from about 10 seconds to about 6 hours, such as from about 30 seconds to about 5 hours, from about 1 minute to about 4 hours, from about 5 minutes to about 3 hours, from about 10 minutes to about 2 hours, from about 20 minutes to about 1 hour, or from about 30 minutes to 40 minutes, including all ranges and subranges therebetween.

Devices

Also disclosed herein are devices comprising a liquid crystal layer and a cover glass sheet positioned proximate the liquid crystal layer and comprising first and second major surfaces, wherein at least one of the first and second major surfaces comprises a depleted surface layer, wherein a surface concentration of at least one alkali metal ion in the depleted surface layer is less than a bulk concentration of the at least one alkali metal ion in the cover glass sheet, and wherein a depth of the depleted surface layer ranges from about 5 nm to about 100 nm.

Further disclosed herein are devices comprising a liquid crystal layer and a cover glass sheet positioned proximate the liquid crystal layer and comprising first and second major surfaces, wherein at least one of a first major surface and a second major surface of the cover glass sheet comprises an enriched surface layer having a silica concentration greater than a bulk silica concentration of the cover glass sheet, and wherein a depth of the enriched surface layer ranges from about 5 nm to about 100 nm.

Referring again to FIG. 1, the devices disclosed herein can include various additional layers or components, such as a polarizer 115, first and second adhesive layers 110, 120, a RX sensor layer 125, a color filter glass 130, a color filter 135, a TFT assembly 145, pixel electrodes 150, a TXNCOM layer 155, and/or a TFT glass 160.

According to various embodiments, at least one of the cover glass 105, first adhesive layer 110, second adhesive layer 120, RX sensor layer 125, color filter glass 130, pixel electrodes 150, TXNCOM layer 155, and TFT glass 160 may be optically transparent. As used herein, the term “transparent” is intended to denote that the component and/or layer has a transmission of greater than about 80% in the visible region of the spectrum (˜400-700nm). For instance, an exemplary component or layer may have greater than about 85% transmittance in the visible light range, such as greater than about 90%, or greater than about 95%, including all ranges and subranges therebetween. The first and second adhesive layers 110, 120 may comprise optically clear adhesives, which may be in the form of adhesive films or adhesive liquids. Non-limiting exemplary thicknesses of the first and/or second adhesive layers 110, 120 may range from about 50 μm to about 500 μm, such as from about 100 μm to about 400 μm, or from about 200 μm to about 300 μm, including all ranges and subranges therebetween. The RX sensor layer 125, pixel electrodes 150, and/or TX/VCOM layer 155 may comprise transparent conductive oxides (TCOs), such as indium tin oxide (ITO) and other like materials. The TX/VCOM layer may also comprise a conductive mesh, e.g., comprising metals such as silver nanowires or other nanomaterials such as graphene or carbon nanotubes.

In non-limiting embodiments, the cover glass 105, color filter glass 130, and/or the TFT glass 160 may comprise optically transparent glass sheets. The glass sheets can have any shape and/or size suitable for use in a display device, such as an LCD touch screen. For example, the glass sheet can be in the shape of a rectangle, square, or any other suitable shape, including regular and irregular shapes and shapes with one or more curvilinear edges.

According to various embodiments, the cover glass 105 can have an overall thickness T (see FIGS. 5A-C) of less than or equal to about 3 mm, for example, ranging from about 0.1 mm to about 2 mm, from about 0.3 mm to about 1.5 mm, from about 0.5 mm to about 1.2 mm, or from about 0.7 mm to about 1 mm, including all ranges and subranges therebetween. According to various embodiments, the glass sheets can have a thickness of less than or equal to 0.3 mm, such as 0.2 mm, or 0.1 mm, including all ranges and subranges therebetween. In certain non-limiting embodiments, the glass sheets can have a thickness ranging from about 0.3 mm to about 1.5 mm, such as from about 0.5 to about 1 mm, including all ranges and subranges therebetween. The color filter glass 130 and TFT glass 160 may also have similar thicknesses according to various embodiments.

The cover glass 105, color filter glass 130, and/or TFT glass 160 may comprise any glass sheets known in the art for use in a display, such as an LCD touch screen, including, but not limited to, soda-lime silicate, aluminosilicate, alkali-aluminosilicate, borosilicate, alkaliborosilicate, aluminoborosilicate, alkali-aluminoborosilicate, and other suitable glasses. In some embodiments, the glass sheets can comprise an alkali-containing glass, e.g., an alkali-containing borosilicate, aluminosilicate, or soda-lime glass. The glass sheets may, in various embodiments, be chemically strengthened and/or thermally tempered. Non-limiting examples of suitable commercially available glasses include EAGLE XG®, Lotus™, Willow®, and Gorilla® glasses from Corning Incorporated, to name a few. Chemically strengthened glass, for example, may be provided in accordance with U.S. Pat. Nos. 7,666,511, 4,483,700, and 5,674,790, which are incorporated herein by reference in their entireties.

In some embodiments, the cover glass 105 may have one or more coatings on the first and/or second major surfaces 105A, 105C, which can serve various functions. For example, at least a portion of the first major surface 105A of the cover glass 105 can be coated with one or more of an anti-fingerprint, anti-smudge, anti-glare, or anti-reflective layer which can, in some embodiments, be non-conductive. In some embodiments, an anti-fingerprint coating may include a buffer layer of SiO₂ and a flourosilane layer. When a user's finger moves across the cover glass with a non-conductive additional coating, static electricity can build up and cannot be quickly dissipated through the non-conductive coating. In some embodiments, the first major surface 105A can be treated to create a depleted surface layer X, enriched surface layer Y, or depleted/enriched surface layer XY that can reduce electrostatic charge generation and/or dissipate electrostatic charge. Alternatively or additionally, the layer(s) X, Y, and/or XY may be present on second major surface 105C or any portion thereof.

According to various embodiments, the depleted and/or enriched layers disclosed herein may reduce or eliminate electrostatic charge generation such that the electric field threshold for modulating the LC layer is not reached. For example, a major surface of the cover glass with a depleted and/or enriched layer can have a surface resistivity ranging from about 10⁵ to about 10¹¹ Ohm/sq, such as from about 10⁶ to about 10¹¹ Ohm/sq, from about 10⁷ to about 10¹⁰ Ohm/sq, or from about 10⁸ to about 10⁹ Ohm/sq, including all ranges and subranges therebetween.

In other embodiments, the devices disclosed herein can quickly dissipate electrostatic charge on the cover glass such that the electric field threshold for modulating the LC layer is not reached. For instance, the cover glass in such display devices may have an electrostatic discharge decay time constant of less than about 1 second, such as less than about 0.5 seconds, e.g., ranging from about 0.1 seconds to about 1 second (such as 0.1, 0.2, 0.3, 0.4, 0.5, 0.6, 0.7, 0.8, 0.9, or 1 second). The decay time constant may be calculated as the amount of time it takes the electrostatic charge to decay by a factor of 1/e (about 36.8% of the original amount). In additional embodiments, the depleted and/or enriched layer may quickly dissipate electrostatic charge such that an electrostatic charge generated on one major surface of the cover glass is reduced to 0 V on the opposing major surface in one second or less, such as less than about 0.5 seconds, e.g., ranging from about 0.1 seconds to about 1 second (such as 0.1, 0.2, 0.3, 0.4, 0.5, 0.6, 0.7, 0.8, 0.9, or 1 second).

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method or device that comprises A+B+C include embodiments where a method or device consists of A+B+C and embodiments where a method or device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Examples are intended to be non-restrictive and illustrative only, with the scope of the invention being defined by the claims.

### EXAMPLES

### Example 1: Ion Exchange

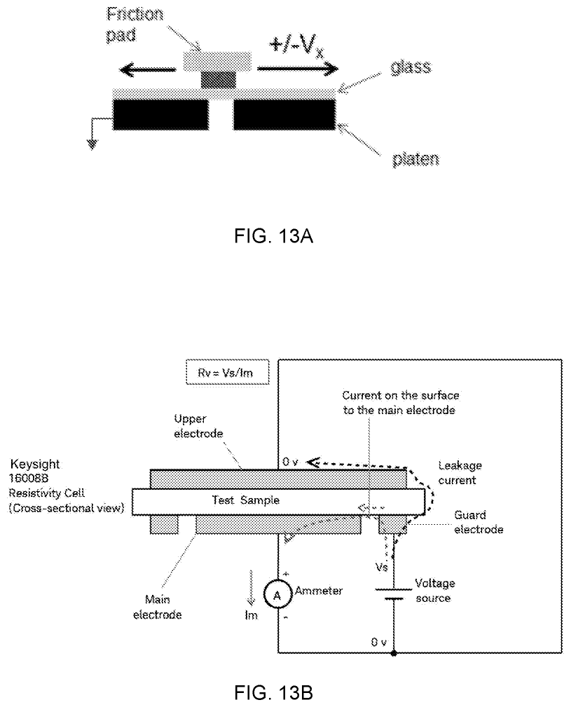

Gorilla® Glass 3 and 5 samples were soaked in a 1M solution of NaNO₃ (8.5% w/v) at 60° C. for a time period of 2 minutes or 10 minutes. After treatment, the glass samples were rinsed with deionized water at room temperature for 10 seconds. The rinsed glass samples were air dried at room temperature for 10 minutes or more and subsequently tested for charge generation using an electrostatic gauge (ESG). A stainless steel friction pad was connected to an electrometer that measures the total charge generated on the glass surface. The glass surface (charge generation area=20 mm×15 mm) was rubbed (load=0.3 lb; 5 cycles) while charging the puck equal and opposite to the glass and measuring the signal with the electrometer. The experimental set-up is illustrated in FIG. 13A.

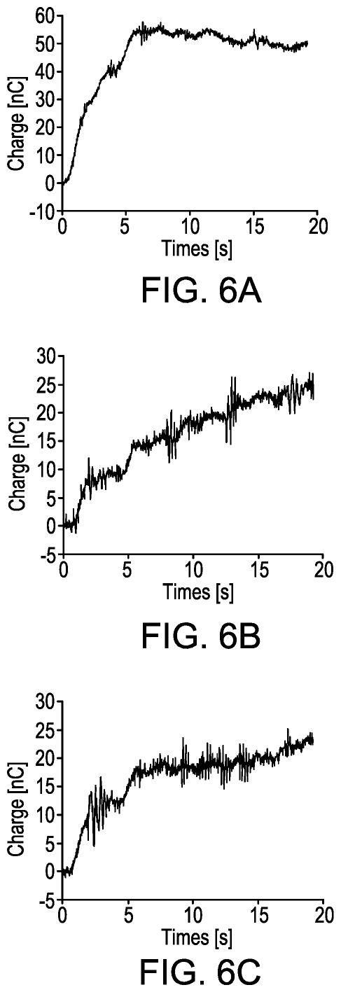

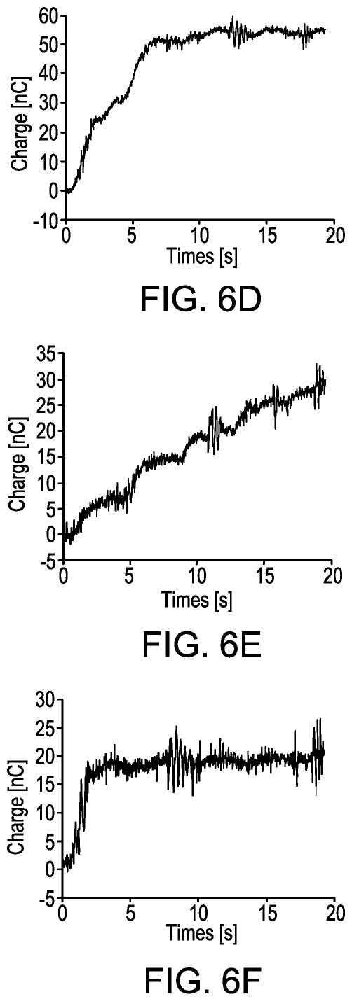

The results of these tests for Gorilla® Glass 3 samples are presented in FIGS. 6A-C. FIG. 6A plots charge generation for an untreated Gorilla® Glass 3 sample, whereas FIGS. 6B-C plot charge generation for Gorilla® Glass 3 samples that were ion exchanged for 2 minutes and 10 minutes, respectively. As can be appreciated from the plots, the ion exchange treatment effectively reduced the charge generation from more than 50 nC for an untreated sample to 30 nC after a treatment time of 2 minutes and as low as 15 nC after a treatment time of 10 minutes. The calculated charge rate on the roller for the untreated Gorilla® Glass 3 sample was 3.91 nC/s, whereas the charge rate for the treated samples was reduced to 1.54 nC/s (2 minutes) and 1.50 nC/s (10 minutes).

The test results for Gorilla® Glass 5 samples are presented in FIGS. 6D-F. FIG. 6D plots charge generation for an untreated Gorilla® Glass 5 sample, whereas FIGS. 6E-F plot charge generation for Gorilla® Glass 5 samples that were ion exchanged for 2 minutes and 10 minutes, respectively. As can be appreciated from the plots, the ion exchange treatment effectively reduced the charge generation from more than 50 nC for an untreated sample to 20 nC after a treatment time of 2 minutes and as low as 15 nC after a treatment time of 10 minutes. The calculated charge rate on the roller for the untreated Gorilla® Glass 5 sample was 4.01 nC/s, whereas the charge rate for the treated samples was reduced to 1.67 nC/s (2 minutes) and 1.14 nC/s (10 minutes).

### Example 2: Ion Exchange

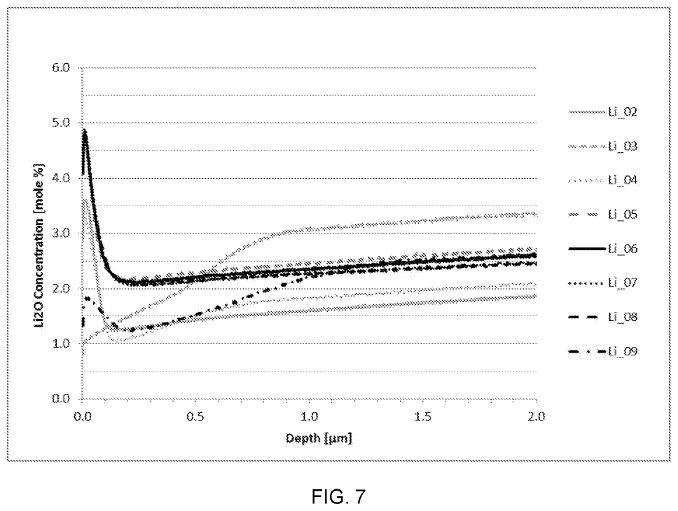

Gorilla® Glass 5 samples were soaked in ion exchange baths with varying concentrations of KNO₃ and/or NaNO₃ for varying time periods and at varying temperatures, which are listed in Table I below. The effect of the different IOX conditions on the amount of Li⁺ ions in the resulting depleted layer is depicted in FIG. 7. As can be appreciated from the plots, different IOX conditions result in different Li⁺ concentrations and the Li⁺ concentration can be higher at a depth of greater than 100 to 200 nm.

TABLE I
Ion Exchange Conditions

| | KNO₃ | NaNO₃ | Temperature | Time |
|---|---|---|---|---|
| | (wt %) | (wt %) | (° C.) | (h) |
| Li_02 | 51 | 49 | 380 | 3.5 |
| Li_03 | 100 | 0 | 380 | 24 |
| Li_04 | 60 | 40 | 380 | 3 |
| Li_05 | 80 | 20 | 380 | 3 |
| Li_06 | 80 | 20 | 380 | 4.5 |
| Li_07 | 80 | 20 | 380 | 7.5 |
| Li_08 | 80 | 20 | 380 | 9.5 |
| Li_09 (step A) | 85 | 15 | 380 | 3 |
| Li_09 (step B) | 95 | 5 | 380 | 0.5 |

### Example 3: Ion Exchange and Etching

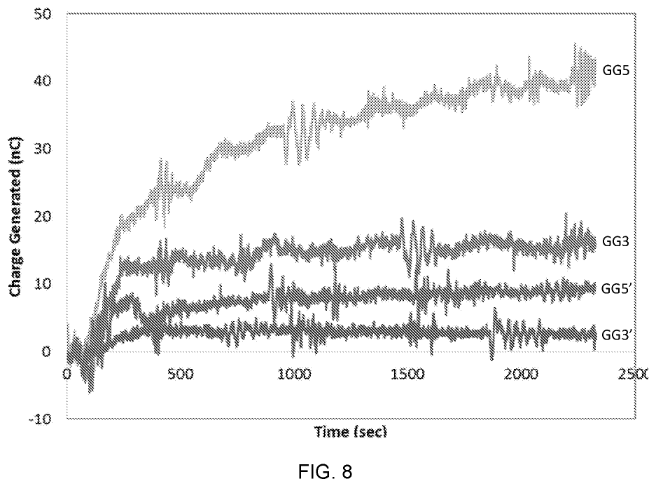

Gorilla® Glass 3 samples were ion exchanged in 100% KNO₃ at 420° C. for 5.5 hours. Gorilla® Glass 5 samples were ion exchanged in a two-step process, with 62 wt % KNO₃ and 38 wt % NaNO₃ at 380° C. for 1 h 25 min in the first step, followed by 91 wt % KNO₃ and 9 wt % NaNO₃ at 380° C. for 33 min in the second step. The ion-exchanged Gorilla® Glass 3 and 5 samples were subsequently treated with an etchant solution comprising NaF (0.4M) and H₃PO₄ (1M) in water for one minute at 40° C. The treated samples were subsequently rinsed in deionized water for 1 minute and air dried at room temperature for 60 minutes. The samples were tested for charge generation using the electrostatic gauge (ESG) discussed in Example 1 with the experimental set-up illustrated in FIG. 13A. The results of this testing are depicted in FIG. 8.

As indicated by the plots in FIG. 8, an approximate 5-6x reduction in charge generation is seen when comparing untreated Gorilla® Glass 3 GG3 to ion-exchanged and etched Gorilla® Glass 3 GG3′, and an approximate 4× reduction in charge generation is seen when comparing untreated Gorilla® Glass 5 GG5 to ion-exchanged and etched Gorilla® Glass 5 GG5′. Charge reduction for an untreated glass sample can therefore be reduced by a combination of ion exchange and etching steps. Without wishing to be bound by theory, it is believed that this charge generation reduction is a result of silica enrichment and depletion of cations (e.g., alkali, alkaline earth, glass-forming, and/or impurity cations) in the treated surface.

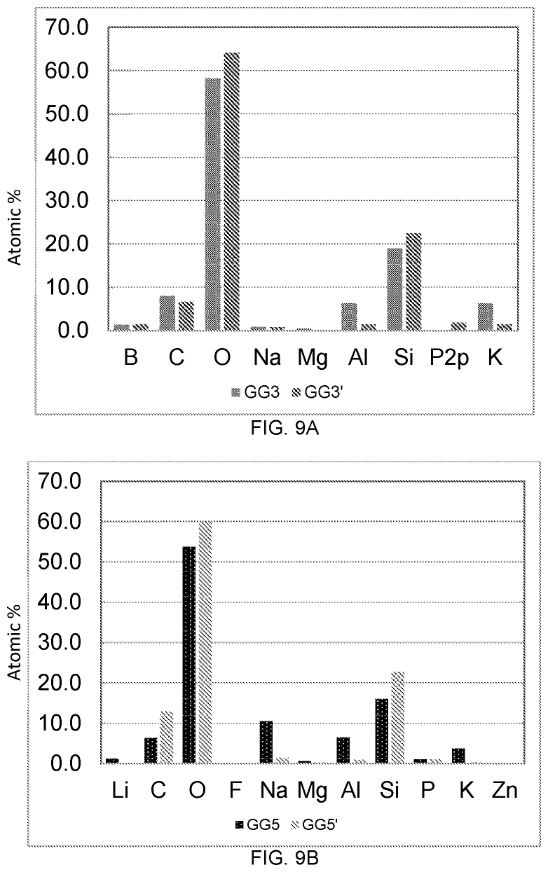

FIGS. 9A-B illustrates photoelectron spectroscopy (XPS) data for the treated and untreated samples and confirms that silica concentration is higher in the ion-exchanged and etched samples GG3′ and GG5′ as compared to the untreated samples GG3 and GG5. Correspondingly, the concentrations of alkali metal cations (e.g., Li, Na, K), alkaline earth metal cations (e.g., Mg), and glass-forming cations (e.g., Al, B, Zn, P) are lower in the ion-exchanged and etched samples GG3′ and GG5′ as compared to the untreated samples GG3 and GG5.

### Example 4: Ion Exchange and Leaching

Gorilla® Glass 3 and 5 samples were ion exchanged as described above in Example 3. The ion-exchanged Gorilla® Glass 3 and 5 samples were subsequently treated with a leachant solution comprising HCI (1M) in water for 2 minutes or 10 minutes at 60° C. The treated samples were subsequently rinsed in deionized water for 1 minute and air dried at room temperature for 5 minutes or more. The samples were tested for charge generation using the electrostatic gauge (ESG) discussed in Example 1 with the experimental set-up illustrated in FIG. 13A.

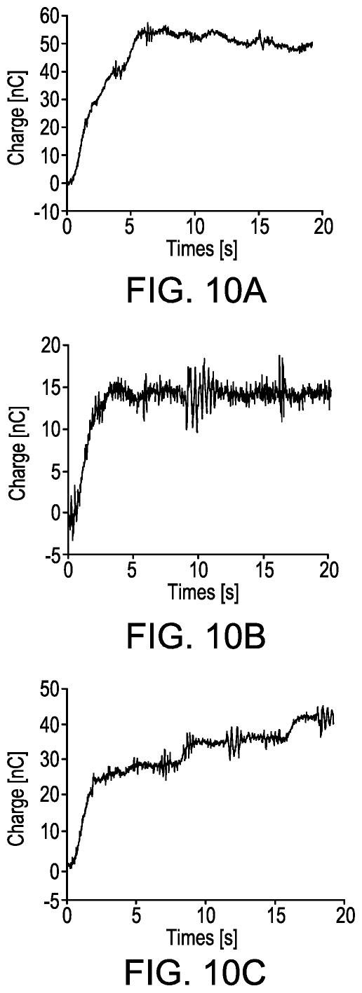

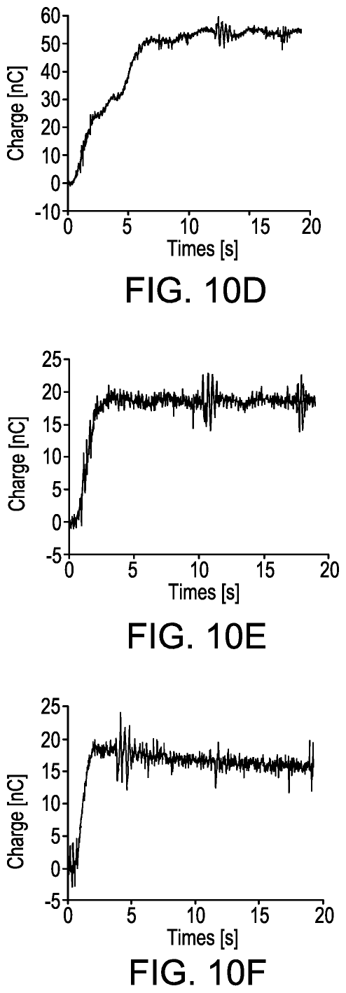

The results of these tests for Gorilla® Glass 3 samples are presented in FIGS. 10A-C. FIG. 10A plots charge generation for an untreated Gorilla® Glass 3 sample, whereas FIGS. 10B plot charge generation for ion-exchanged Gorilla® Glass 3 samples that were leached for 2 minutes and 10 minutes, respectively. As can be appreciated from the plots, the ion exchange and leaching treatments effectively reduced the charge generation from more than 50 nC for an untreated sample to 15 nC after a ion exchange and leaching for 2 minutes and to 30 nC after ion exchange and leaching for 10 minutes. The calculated charge rate on the roller for the untreated Gorilla® Glass 3 sample was 3.91 nC/s, whereas the charge rate for the treated samples was reduced to 1.10 nC/s (2 minutes) and 2.77 nC/s (10 minutes).

The test results for Gorilla® Glass 5 samples are presented in FIGS. 10D-F. FIG. 10D plots charge generation for an untreated Gorilla® Glass 5 sample, whereas FIGS. 10E-F plot charge generation for ion-exchanged Gorilla® Glass 5 samples that were leached for 2 minutes and 10 minutes, respectively. As can be appreciated from the plots, the ion exchange and leaching treatments effectively reduced the charge generation from more than 50 nC for an untreated sample to 20 nC after ion exchange and leaching for 2 minutes and as low as 15 nC after ion exchange and leaching for 10 minutes. The calculated charge rate on the roller for the untreated Gorilla® Glass 5 sample was 4.01 nC/s, whereas the charge rate for the treated samples was reduced to 1.44 nC/s (2 minutes) and 1.26 nC/s (10 minutes).

### Example 5: Surface Resistivity and Conductivity

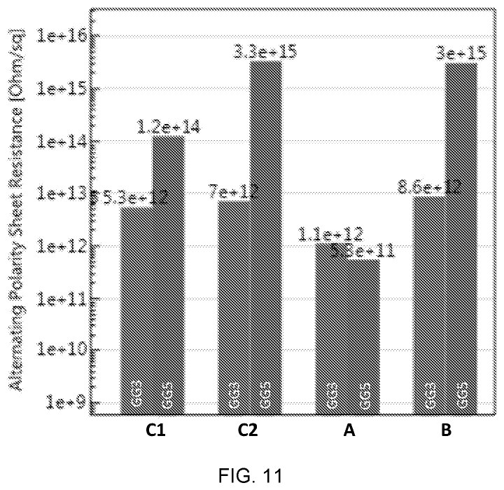

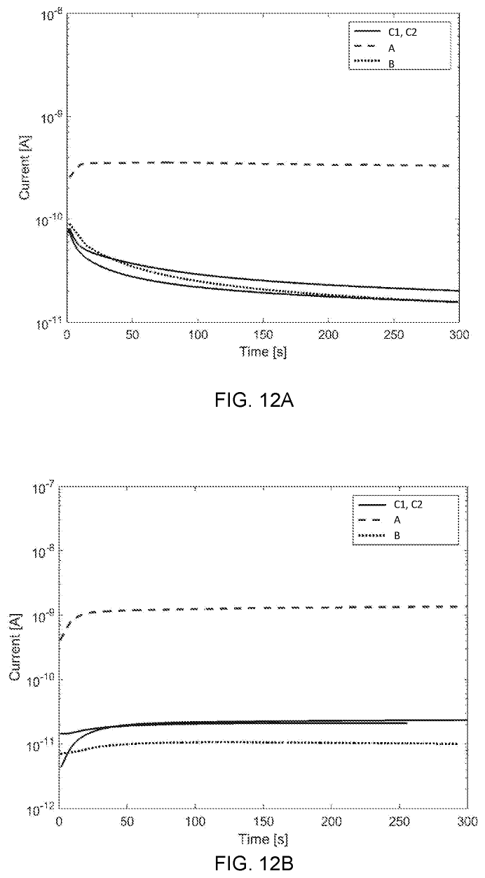

Resistivity for untreated Gorilla® Glass 3 and 5 control samples, ion-exchanged Gorilla® Glass 3 and 5 samples (NaNO₃, 1M, 10 minutes, 60° C.), and leached Gorilla® Glass 3 and 5 samples (HCl, 1M, 10 minutes, 60° C.) was measured using a Keysight B2987A electrometer. Using a Keysight 16008B Resistivity Cell fixture, the samples were pressed by 7 kg of force between two concentric electrodes with a perimeter of 188.5 mm and a gap of 10 mm between the inner and outer electrodes. The experimental set-up, as provided by Keysight, is illustrated in FIG. 13B. Resistivity was measured using an alternate polarity method in which the source voltage was changed from +20 V to −20 V approximately every 8 seconds. The difference in the values of the current right before switching the voltage polarity was used for deriving the sheet resistance. The results of this testing are provided in FIG. 11. After setting the DC source voltage to 20V, the conductivity of the glass surface was also measured. The results of this testing are provided in FIGS. 12A-B.

As shown in FIG. 11, leached Gorilla® Glass 3 and 5 samples A exhibited decreased sheet resistance as compared to untreated samples C1 and C2. Ion-exchanged Gorilla® Glass 3 and 5 samples B exhibited comparable (within expected standard deviation) sheet resistance as compared to untreated samples C1 and C2. Similarly, as shown in FIGS. 12A-B, leached Gorilla® Glass 3 and 5 samples A exhibited a higher surface DC current compared to untreated samples C1 and C2, indicating higher surface conductivity. Ion-exchanged Gorilla® Glass 3 and 5 samples B exhibited comparable (within expected standard deviation) surface DC current as compared to untreated samples C1 and C2. Without wishing to be bound by theory, it is believed that higher surface conductivity can aid in more quickly dissipating surface charge, directing it towards the edges of the cover glass and away from the underlying LC layer when installed in a display or electronic device.

1. A method for reducing mura in a touch-display device, the method comprising:
(a) treating a cover glass sheet to produce a depleted surface layer on at least one of a first major surface or a second major surface of the cover glass sheet; and
(b) positioning the cover glass sheet proximate a liquid crystal layer in a touch-display device,
wherein a surface concentration of at least one alkali metal ion in the depleted surface layer is less than a bulk concentration of the at least one alkali metal ion in the cover glass sheet; and
wherein a depth of the depleted surface layer ranges from about 5 nm to about 100 nm.

2. The method of claim 1, wherein the cover glass sheet comprises an alkali-containing glass chosen from borosilicate, aluminosilicate, and soda-lime glasses.

3. The method of claim 1, wherein the treating the cover glass sheet comprises an ion exchange step.

4. The method of claim 3, wherein the ion exchange step comprises a temperature ranging from about 20° C. to about 120° C.

5. The method of claim 3, wherein the ion exchange step comprises a treatment period ranging from about 30 seconds to about 10 minutes.

6. The method of claim 3, wherein the ion exchange step comprises contacting at least one of the first and second major surfaces of the cover glass sheet with a salt bath comprising at least one cation chosen from H₃O⁺, Na⁺, K⁺, Cs⁺, Ag⁺, and Au⁺.

7. The method of claim 1, wherein treating the cover glass sheet comprises a leaching or etching step.

8. The method of claim 7, wherein the leaching or etching step comprises contacting at least one of the first and second major surfaces of the cover glass sheet with a leachant or etchant comprising at least one compound chosen from fluoride compounds, mineral acids, organic acids, and combinations thereof.

9. The method of claim 8, wherein the etchant comprises a combination of (a) at least one fluoride compound and (b) at least one of a mineral acid and organic acid.

10. The method of claim 8, wherein the at least one compound is chosen from HF, NH₄F, F₂H₅N, NaF, KF, HCl, HNO₃, H₂SO₄, H₃PO₄, and CH₃COOH.

11. The method of claim 7, wherein the leaching or etching step comprises a temperature ranging from about 20° C. to about 90° C.

12. The method of claim 7, wherein the leaching or etching step comprises a treatment time ranging from about 10 seconds to about 10 minutes.

13. The method of claim 1, wherein treating the cover glass sheet comprises an ion exchange step and a leaching or etching step.

14. The method of claim 13, wherein the leaching or etching step is performed after the ion exchange step.

15. A method for reducing mura in a touch-display device, the method comprising:
(a) treating a cover glass sheet to produce an enriched surface layer on at least one of a first major surface or a second major surface of the cover glass sheet; and
(b) positioning the cover glass sheet proximate a liquid crystal layer in a touch-display device,
wherein a silica concentration of the enriched surface layer is greater than a bulk silica concentration of the cover glass sheet; and
wherein a depth of the enriched surface layer ranges from about 5 nm to about 100 nm.

16. The method of claim 15, wherein treating the cover glass sheet comprises a leaching or etching step.

17. The method of claim 16, wherein the leaching or etching step comprises contacting at least one of the first and second major surfaces of the cover glass sheet with a leachant or etchant comprising at least one compound chosen from fluoride compounds, mineral acids, organic acids, and combinations thereof.

18. The method of claim 17, wherein the etchant comprises a combination of (a) at least one fluoride compound and (b) at least one of a mineral acid and organic acid.

19. The method of claim 17, wherein the at least one compound is chosen from HF, NH₄F, F₂H₅N, NaF, KF, HCl, HNO₃, H₂SO₄, H₃PO₄, and CH₃COOH.

20. The method of claim 16, wherein the leaching or etching step comprises a temperature ranging from about 20° C. to about 90° C.

21. The method of claim 16, wherein the leaching or etching step comprises a treatment time ranging from about 10 seconds to about 10 minutes.

22. A device comprising:
(a) a liquid crystal layer; and
(b) a cover glass sheet positioned proximate the liquid crystal layer, the cover glass sheet comprising first and second major surfaces;
wherein at least one of the first and second major surfaces comprises a depleted surface layer,
wherein a surface concentration of at least one alkali metal ion in the depleted surface layer is less than a bulk concentration of the at least one alkali metal ion in the cover glass sheet; and
wherein a depth of the depleted surface layer ranges from about 5 nm to about 100 nm.

23. The device of claim 22, wherein the cover glass sheet comprises an alkali-containing glass chosen from borosilicate, aluminosilicate, and soda-lime glasses.

24. The device of claim 22, wherein the alkali metal ion is lithium.

25. The device of claim 22, wherein the surface concentration of the at least one alkali metal ion in the depleted surface layer ranges from 0 mol % to about 5 mol %.

26. The device of claim 22, wherein both the first and second major surfaces of the cover glass sheet comprise a depleted surface layer.

27. A device comprising:
(a) a liquid crystal layer; and
(b) a cover glass sheet positioned proximate the liquid crystal layer;
wherein at least one of a first major surface and a second major surface of the cover glass sheet comprises an enriched surface layer having a silica concentration greater than a bulk silica concentration of the cover glass sheet; and
wherein a depth of the enriched surface layer ranges from about 5 nm to about 100 nm.

28. The device of claim 27, wherein the silica concentration of the enriched surface layer is at least about 1 mol % greater than the bulk silica concentration of the cover glass sheet.

29. The device of claim 27, wherein both the first and second major surfaces of the cover glass sheet comprise an enriched surface layer.

30. The device of claim 24, wherein the device is a liquid crystal touch-display further comprising at least one of a polarizer, a receive (RX) sensor layer, a transmit (TX) sensor layer, a thin film transistor (TFT) array, a color filter glass, a color filter, and an anti-finger print layer.
